(19) United States
(12) Patent Application Publication
(10) Pub. No.: US 2025/0242752 A1
(43) Pub. Date: Jul. 31, 2025

(54) FOLDABLE PANEL FOR FACILITATING SPOTTING OF ON ROAD HAZARDS

(71) Applicant: Hector Guillermo Villavicencio, Hesperia, CA (US)

(72) Inventor: Hector Guillermo Villavicencio, Hesperia, CA (US)

(21) Appl. No.: 18/427,482

(22) Filed: Jan. 30, 2024

(51) Int. Cl. B60Q 1/52; B60Q 1/30

(52) U.S. Cl. CPC B60Q 1/52; B60Q 1/3015

(57) ABSTRACT

A foldable hazard warning panel configured to be deployed on a vehicle is described. The foldable hazard warning panel comprises a set of beams, a first set of shafts and a second set of shafts detachably and pivotally coupled to the set of beams, and a plurality of lights deployed on the set of beams and the first and second set of shafts. The foldable hazard warning panel is configured to shift between a fully open state, a partially folded state, and a fully folded state. The plurality of lights are operative to indicate presence of a hazard and a safe direction of travel.

Has a Bluetooth 70 feet Bluetooth Wireless Range capability mounted camera on beam, solar panel strip charger capability attached to beams and to continue to operate in case of total loss of power occurs, heat capability throughout all device frame to melt snow, sleet or freezing rain while operating, USB charging plug capability that pre-charges the foldable panel while being stored, and a electronic device power supply that connects the license plate of the vehicle to the foldable panel for continuous operation while in an emergency

### FIELD OF THE INVENTION

The present invention relates generally to hazard warning panels, and more particularly to foldable hazard warning panels that can easily be deployed in a desired manner.

### BACKGROUND OF THE INVENTION

Generally, a vehicle may need to stop on a road due to accidents and collisions, or in case of vehicle breakdown due to engine or tire problems. In such scenarios, a driver of the vehicle uses multiple triangular shaped elements to indicate to other vehicles that there is a hazard on the road. A user has to place the elements on the road at different locations so as to indicate to the other vehicles a safe direction of travel, however, such placing of multiple elements is cumbersome. Further, these elements occupy a lot of storage space in the vehicle, and it is difficult to travel with multiple such elements. Moreover, these elements have low visibility and may not allow sufficient time for an approaching vehicle to take evasive action.

Accordingly, there is an established need for a solution to the problems mentioned above. For instance, there is an established need for a panel that facilitates spotting of an on-road hazard from a greater distance. There is an established need for a panel that can be stored easily in a compact form and thus can be used with vehicles having less storage space. There is an established need for a panel that can be deployed quickly to a back of a vehicle and has excellent visibility.

### SUMMARY OF THE INVENTION

The present invention relates to a foldable hazard warning panel configured to be deployed on a vehicle. The foldable hazard warning panel comprises a set of beams; a first set of shafts and a second set of shafts detachably and pivotally coupled to the set of beams; and a plurality of lights provided on the set of beams and the first and second set of shafts, wherein the foldable hazard warning panel is configured to shift between a fully open state, a partially folded state, and a fully folded state, and wherein the plurality of lights are operative to indicate presence of a hazard, and a safe direction of travel.

In an aspect, the set of beams comprises a first beam, and a second beam and a third beam pivotally coupled to the first beam.

In an aspect, each of the second beam and the third beam form an acute angle with the first beam in the open state of the foldable hazard warning panel.

In an aspect, the second beam and the third beam comprise respective tapered edges.

In an aspect, in the open state of the foldable hazard warning panel, the set of beams have a triangular shape.

In an aspect, the first set of shafts comprises a first shaft, and a second shaft and a third shaft pivotally coupled to the first shaft.

In an aspect, in the open state of the foldable hazard warning panel, the first set of shafts have a shape resembling an arrow. The arrow being indicative of a safe direction of travel.

In an aspect, the second set of shafts comprises a fourth shaft, and a fifth shaft and a sixth shaft pivotally coupled to the fourth shaft.

In an aspect, in the open state of the foldable hazard warning panel, the second set of shafts have a shape resembling an arrow. The arrow being indicative of a safe direction of travel.

In an aspect, the plurality of lights provided on the set of beams when turned ON indicate the presence of a hazard.

In an aspect, the plurality of lights provided on the first set of shafts when turned ON indicate a first safe direction of travel.

In an aspect, the plurality of lights provided on the second set of shafts when turned ON indicate a second safe direction of travel, the second safe direction being opposite to the first safe direction.

These and other objects, features, and advantages of the present invention will become more readily apparent from the attached drawings and the detailed description of the embodiments and examples, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 illustrates a perspective view of a foldable hazard warning panel, the foldable hazard warning panel in an open state, in accordance with one embodiment of the present specification;

FIG. 2 illustrates a perspective view of the foldable hazard warning panel, the foldable hazard warning panel in a partially folded state, in accordance with one embodiment of the present specification;

FIG. 3 illustrates a perspective view of the foldable hazard warning panel, the foldable hazard warning panel being in a fully folded state, in accordance with one embodiment of the present specification;

FIG. 4 illustrates a perspective view of the foldable hazard warning panel, the foldable hazard warning panel in a fully folded state, in accordance with one embodiment of the present specification;

FIG. 5 illustrates a perspective view of the foldable hazard warning panel, the foldable hazard warning panel in an open state and having a plurality of lights in operation, in accordance with one embodiment of the present specification;

FIG. 6 illustrates the foldable hazard warning panel being deployed on a vehicle, in accordance with one embodiment of the present specification;

FIG. 7 illustrates the foldable hazard warning panel being deployed on another vehicle, in accordance with another embodiment of the present specification.

FIG. 8 illustrates the foldable hazard warning panel in a fully folded state with the location of the camera lenses, in accordance with one embodiment of the present specification; and

FIG. 9 illustrates the foldable hazard warning panel is a fully folded state with the location of the control switch board, in accordance with one embodiment of the present specification

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other embodiments.

All of the embodiments described below are exemplary embodiments provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in the drawings. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disfolded herein are not to be considered as limiting, unless the claims expressly state otherwise.

In the following description, certain specific details are set forth in order to provide a thorough understanding of various disfolded embodiments. However, one skilled in the relevant art will recognize that embodiments may be practiced without one or more of these specific details, or with other methods, components, materials, and the like. In other instances, well-known elements associated with hazard spotting panels have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

As used in this specification and the appended claims, the singular forms “a,” “an, and “the” include plural referents unless the content clearly dictates otherwise, and the vice versa. It should also be noted that the term “or” is generally employed in its broadest sense, that is, as meaning “and/or” unless the content clearly dictates otherwise.

The headings and Abstract of the Disclosure provided herein are for convenience only and do not interpret the scope or meaning of the embodiments.

Shown throughout the drawings, the present invention is directed towards a foldable or collapsible hazard warning panel that can assume a compact state for being easily carried in a storage space of a vehicle and an extended, open state for use in case of hazard situations on-road to provide warnings to other vehicles.

It should be noted that throughout the specification and claims which follow, the term “hazard” refers to a situation on road that may cause harm to vehicles. For instance, a vehicle stopping on road due to breakdown may be an obstruction for other vehicles travelling on the road, and it is important to spot such hazards to avoid accidents.

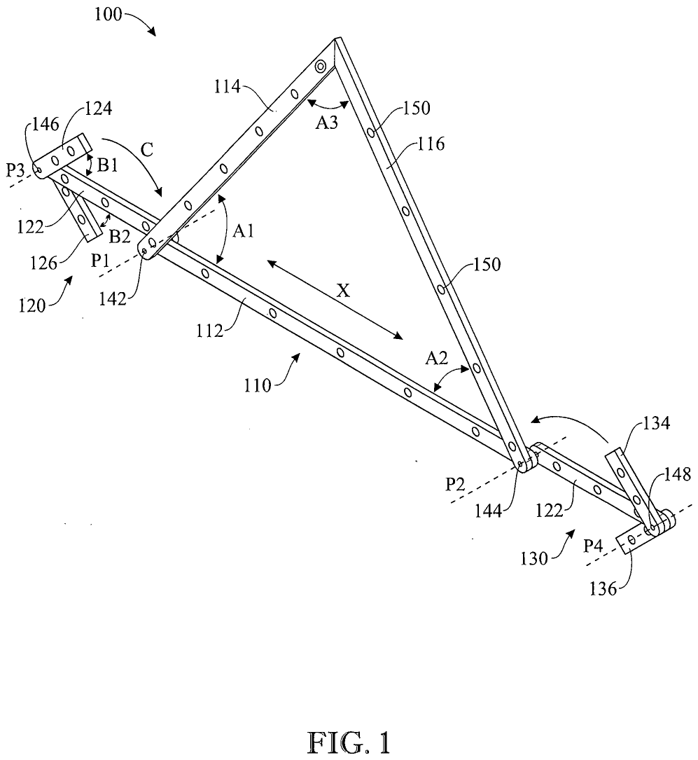

Reference is initially made to FIG. 1 that illustrates a foldable hazard warning panel 100 in a fully open state. The foldable hazard warning panel 100 is configured to be shifted between a fully open state, a partially folded state, and a fully folded state. The foldable hazard warning panel 100 may be carried in a vehicle in a fully folded state without occupying much space and can be expanded and positioned in an appropriate location in a time of need. The foldable hazard warning panel 100 is formed of a plurality of beams and shafts that are configured to take different orientations so as to allow the foldable hazard warning panel 100 to be in the fully open state, the partially folded state, and the fully folded state.

The foldable hazard warning panel 100 comprises a set of beams 110 that comprises a first beam 112, a second beam 114, and a third beam 116. The first beam 112 is coupled to the second beam 114 and the third beam 116. As illustrated in FIG. 1, the first beam 112 and the second beam 114 are coupled to each other at one of the respective ends by means of a first pivot pin 142 having a first pivot axis P1. The second beam 114 is configured to be pivoted about the first pivot axis P1 of the first pivot pin 142, thereby allowing the second beam 114 and the first beam 112 to be pivotally coupled to each other.

In a similar manner, the first beam 112 is coupled to the third beam 116 at one of the respective ends by means of second pivot pin 144 having a second pivot axis P2. It is appreciated that the end of the first beam 112 coupled to the third beam 116 is the end opposite to the end at which the second beam 114 is coupled thereto. The third beam 116 is configured to be pivoted about the second pivot axis P2 of the second pivot pin 144, thereby allowing the third beam 116 and the first beam 112 to be pivotally coupled to each other.

The first beam 112, the second beam 114, and the third beam 116 may be formed of a suitable material, such as aluminum, which allows the foldable hazard warning panel 100 to be deployed as and when required. The beams 112, 114, 116 may be hollow rectangular beams that may have large dimensions as compared to conventionally used hazard warning signs to provide greater visibility, however, are not heavy and can easily be positioned appropriately by a user, such as a driver of a vehicle.

The first beam 112 extends along a longitudinal direction, as shown by arrow X. The pivot pins 142, 144 are disposed so as to extend substantially perpendicular to the longitudinal direction X of the first beam 112, and thus, the pivot axis P1 and P2 also extend substantially perpendicular to the longitudinal direction X.

As seen in FIG. 1, the second beam 114 and the third beam 116, in the fully open position of the foldable hazard warning panel 100, form an angle with the first beam 112. In the illustrated embodiment, the angle A1 between the first beam 112 and the second beam 114 as well as the angle A2 between the first beam 112 and the third beam 116 is an acute angle. In an example, each of the angle A1 and A2 is 60 degrees.

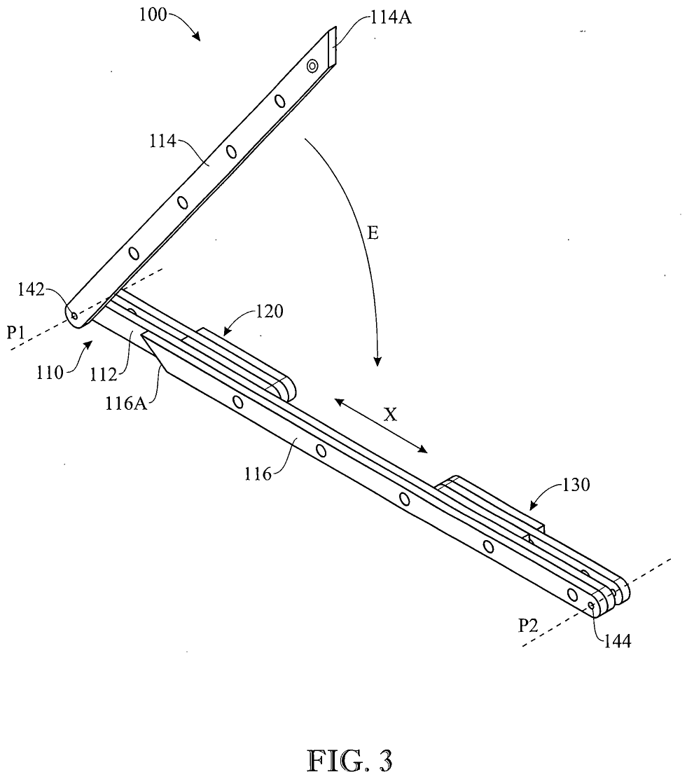

In addition, in the fully open state of the foldable hazard warning panel 100, the second beam 114 and the third beam 116 are in connection with each other via the respective ends distal to the pivot pins 142, 144. The distal end of the second beam 114 has a tapered edge 114A (best seen in FIG. 3) while the distal end of the third beam 116 has a tapered edge 116A (best seen in FIG. 3). In the fully open state of the foldable hazard warning panel 100, the tapered edges 114A, 116A of the second beam 114 and the third beam 116 face each other so as to connect the second beam 114 and the third beam 116. In an example, the connection between the second beam 114 and the third beam 116 is a friction fit connection. In another example, the connection between the second beam 114 and the third beam 116 may be secured by means of a removable securing means, such as, a male-female snap fit or the like.

The second beam 114 and the third beam 116 form an angle A3 when connected at the tapered edges 114A, 116A. The angle A3 may be an acute angle. In an example, the angle A3 is 60 degrees. Accordingly, the first beam 112, the second beam 114, and the third beam 116, in the fully open position of the foldable hazard warning panel 100, form a triangular structure by virtue of the angles A1, A2, A3 there-between. In an example, the triangular structure assumes the shape of an equilateral triangle. It is appreciated that the angles A1, A2, A3 are not limited to be 60 degrees and can vary to be an angle greater than or less than 60 degrees.

The foldable hazard warning panel 100 further comprises a first set of shafts 120 coupled to the set of beams 110. The first set of shafts comprises a first shaft 122, a second shaft 124, and a third shaft 126. In an example, the shafts 122, 124, 126 may be formed of a similar material as the material used to form the set of beams 110. In another example, the shafts 122, 124, 126 may be formed of a different materials. In an example, each of the shafts 122, 124, 126 are formed of aluminum. The shafts 122, 124, 126 may be hollow rectangular beams that are easily deployed and positioned by a user and provide excellent visibility.

The first shaft 122 is coupled to the set of beams 110 by means of the first pivot pin 142. In particular, the first shaft 122 is pivotally coupled to the first beam 112 and the second beam 114, the first shaft 122 being configured to pivot about the first pivot axis P1. Accordingly, the first pivot pin 142 couples the first beam 112, the second beam 114, and the first shaft 122 such that the second beam 114 as well as the first shaft 122 can pivot about the first pivot axis P1 to change respective orientations with respect to the first beam 112.

The first set of shafts 120 further comprises a second shaft 124 and a third shaft 126, each being coupled to the first shaft 122 at a distal end thereof, i.e., an end of the first shaft 122 distal to the end at which the first shaft 122 is connected to the set of beams 110. The second shaft 124 and the third shaft 126 are pivotally coupled to the first shaft 122 by means of a third pivot pin 146 having a third pivot axis P3.

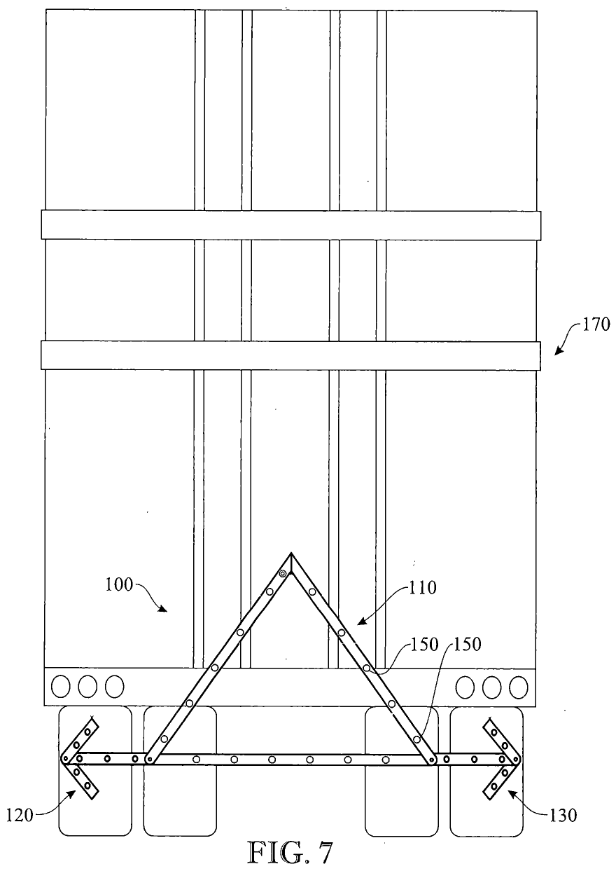

As illustrated in FIG. 1, the second shaft 124 and the third shaft 126 are angled with respect to the first shaft 122, the second shaft 124 forming an angle B1 with the first shaft 122 and the third shaft 126 forming an angle B2 with the first shaft 122. In an example, the angles B1, B2 are acute angles such that in the fully open state of the foldable hazard warning panel 100, the first set of shafts 120 have a structure resembling an arrow. The arrow being indicative of a safe direction of travel (described in detail with relation to FIG. 7). In an example, the angles B1, B2 are equal. In another example, the angles B1, B2 may be different from each other.

The first shaft 122 extends along a direction parallel to the longitudinal direction X of the first beam 112. The second shaft 124 and the third shaft 126 are configured to be pivoted to be parallel to the first shaft 122 when it is required to change the state of the foldable hazard warning panel 100 from the fully open state to a partially folded state or a fully folded state. In addition, the first shaft 122 is configured to be pivoted in a clockwise direction till the first shaft 122 is again parallel to the first beam 112, as shown by arrow C, when it is required to change the state of the foldable hazard warning panel 100 from the fully open state to a partially folded state or a fully folded state.

In an embodiment, the first set of shafts 120 are coupled to the first beam 112 in a detachable manner via the first pivot pin 142. As and when required, the first set of shafts 120 can be detached from the first beam 112. For instance, a hazard situation on road may require usage of only the first set of shafts 120 and the usage of the set of beams 110 may not be necessary to facilitate spotting of the hazard. Similarly, a hazard situation may be such that a user may want to use the set of beams 110 without coupling the first set of shafts 120 thereto to facilitate spotting of the hazard.

The foldable hazard warning panel 100 further comprises a second set of shafts 130 similar to the first set of shafts 120. The second set of shafts 130 comprises a fourth shaft 132 extending parallel to the first beam 112 and pivotally coupled to the first beam 112 by means of the second pivot pin 144 so as to pivot about the second pivot axis P2. The second set of shafts 130 further comprise a fifth shaft 134 and a sixth shaft 136 coupled to the fourth shaft 132 via a fourth pivot pin 148 having a fourth pivot axis P4. It is appreciated that the description provided above for the first set of shafts 120, such as regarding the angles B1, B2, and the orientation and pivoting of the shafts with respect to the set of beams 110, is applicable for the second set of shafts 130 as well. It is appreciated that in the illustrated embodiment, while the first set of shafts 120 pivot in a clockwise direction, the second set of shafts 130 pivots in an anti-clockwise direction. In an implementation, in the fully open state of the foldable hazard warning panel 100, the second set of shafts 130 have a structure resembling an arrow. The arrow being indicative of a safe direction of travel (described in detail with relation to FIG. 7).

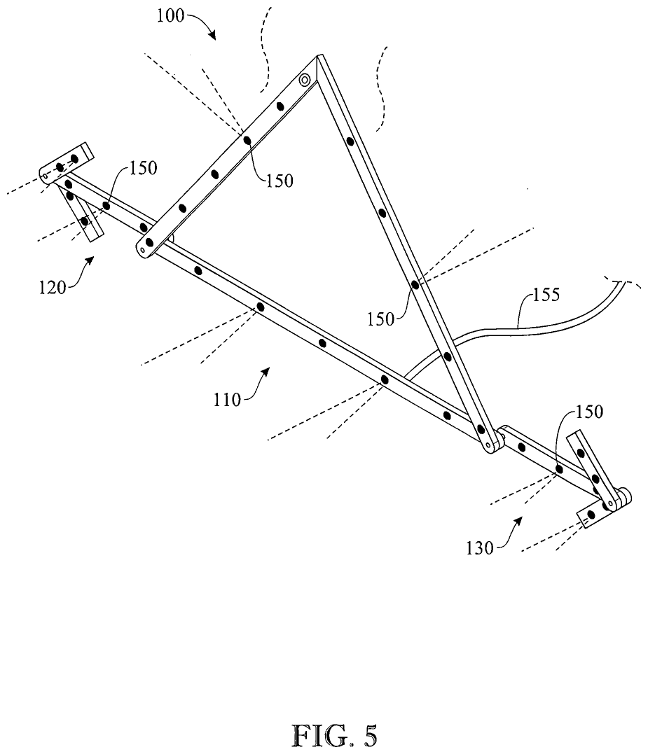

The foldable hazard warning panel 100 further comprises a plurality of lights 150 to allow the foldable hazard warning panel 100 to be visible to greater distances, especially after sundown. The plurality of lights will be detailed with reference to FIG. 5. It is appreciated that the foldable hazard warning panel 100 may comprise means to control the operation of the plurality of lights 150 so as to select whether all the lights 150 are to be utilized or some of the lights 150 are to be utilized. Further, the means may be utilized to select whether the lights 150 are operated continuously or in a blinking manner.

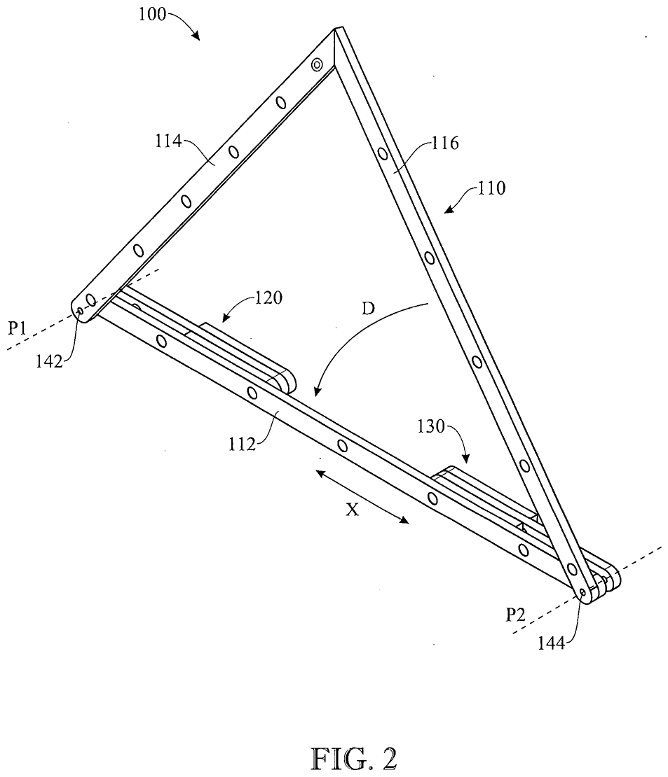

Reference is now made to FIG. 2 that illustrates the foldable hazard warning panel 100 in a partially folded state. The foldable hazard warning panel 100 is still configured to be used, for instance, by attaching to a vehicle. This is because even though the first set of shafts 120 and the second set of shafts 130 have been pivoted to be parallel to the first beam 112 of the set of beams 110, the second beam 114 and the third beam 116 are in connection with each other at the respective tapered edges 114A, 116A.

As seen in FIG. 2, the shafts constituting the first set of shafts 120 have been pivoted about the first pivot axis P1 while the shafts constituting the second set of shafts 130 have been pivoted about the second pivot axis P2. With the orientation as shown in FIG. 1, the first set of shafts 120 undergo a clockwise pivoting rotation while the second set of shafts 130 undergo an anti-clockwise pivoting rotation about the respective pivot axis P1, P2. It is appreciated that prior to the pivoting of the first set of shafts 120 and the second set of shafts 130 about the respective pivot axis P1, P2, the second and third shafts 124, 126 of the first set of shafts 120 and the fifth and sixth shafts 134, 136 of the second set of shafts 130 may be pivoted about the respective pivot axis P3, P4.

Accordingly, a partially folded state of the foldable hazard warning panel 100 is achieved in which the first set of shafts 120 and the second set of shafts 130 extend parallel to the first beam 112 along the longitudinal direction X. As illustrated in FIG. 2, the first set of shafts 120 and the second set of shafts 130 are pivoted so as to fold within an external perimeter defined by the first beam 112, second beam 114, and the third beam 116, and hence, the overall dimensions of the foldable hazard warning panel 100 in the partially folded state is less that the dimensions of the foldable hazard warning panel 100 in the fully open state.

When it is desired to shift the foldable hazard warning panel 100 from the partially folded state to the fully folded state, the third beam 116 of the set of beams 110 is pivoted about the second pivot axis P2, as shown by arrow D. Referring now to FIG. 3, the foldable hazard warning panel 100 being shifted from the partially folded state to the fully folded state is illustrated. The first set of shafts 120 and the second set of shafts 130 have been pivoted about the respective pivot axis P1, P2 so as to extend parallel to the first beam 112.

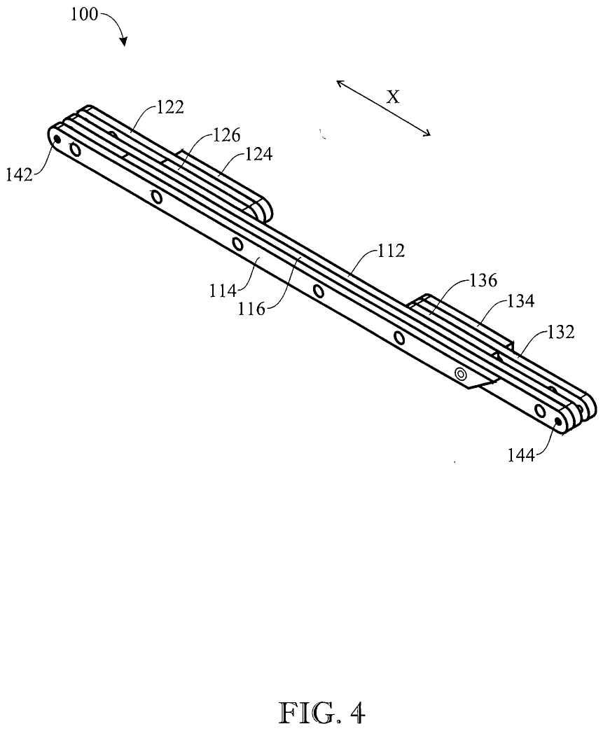

Further, the third beam 116 is pivoted about the second pivot axis P2, as shown by arrow D in FIG. 2. In the illustrated orientation, the third beam 116 is pivoted in an anticlockwise direction about the second pivot axis P2. Post the pivoting, the third beam 116 extends parallel to the first beam 112 along the longitudinal direction X of the first beam 112. The second beam 114 of the set of beams 110 is now to be pivoted about the first pivot axis P1, as shown by arrow E. Referring now to FIG. 4, the foldable hazard warning panel 100 in the fully folded state is illustrated after shifting from the partially folded state. The second beam 114 have been pivoted about the first pivot axis P1 so as to extend parallel to the first beam 112 in the longitudinal direction X.

Accordingly, in the fully folded state of the foldable hazard warning panel 100, each of the beams 112, 114, 116 constituting the set of beams 110 extend in the longitudinal direction X. In addition, each shafts constituting the first set of shafts 120 and the second set of shafts 130 also extend parallel to the longitudinal axis X. Thus, the foldable hazard warning panel 100 in the fully foldable state has an overall dimension much lesser that the dimension in the fully open state. This allows the foldable hazard warning panel 100 to be conveniently carried in a vehicle without occupying much storage space. In case of a hazard on road, a user, such as a driver of the vehicle, can easily shift the foldable hazard warning panel 100 to its partially folded state or fully open state for use.

Reference is now made to FIG. 5 that illustrates the foldable hazard warning panel 100 in the fully open position, with a lighting arrangement being operated and emitting light. The foldable hazard warning panel 100 comprises a plurality of lights 150 forming the lighting arrangement, the lights being provided on the surface of the foldable hazard warning panel 100 that would face towards an exterior of the vehicle so as to be visible from other vehicles.

The plurality of lights 150 may be provided on the beams constituting the set of beams 110 as well as the shafts constituting the set of shafts 120, 130. The plurality of lights 150 may be operated when connected to an external power source. In an embodiment, the external power source may be a battery of the vehicle. In order to facilitate the operation of the plurality of lights 150, the foldable hazard warning panel 100 may comprise a power cable 155 to establish connection between the lights 150 and the external power source. Each of the lights 150 may be in electrical connection with the power cable 155, as would be apparent to a skilled person in view of the disclosure. It is appreciated that the lights may emit any suitable color to provide good visibility to the foldable hazard warning panel 100. In an example, the lights may emit an orange color. In an examples, the lights 150 may comprise light emitting diodes (LEDs).

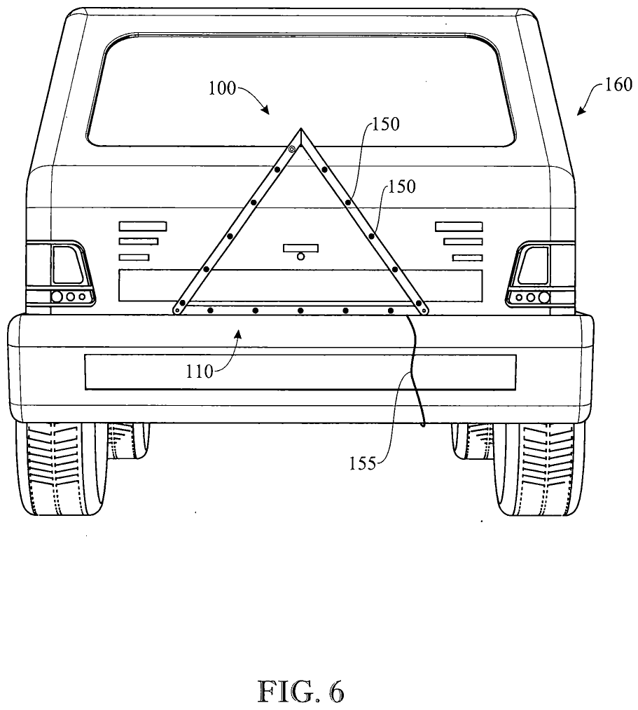

Reference is now made to FIG. 6 which illustrates the foldable hazard warning panel 100 being attached to a vehicle 160. In the illustrated embodiment, only the set of beams 110 of the foldable hazard warning panel 100 are being used. In one example, the foldable hazard warning panel 100 is in the partially folded state such that the first and second set of shafts 120, 130 are pivoted to be parallel to the first beam 112 and behind the first beam 112 so as to be hidden from view. In another example, the first and second set of shafts 120, 130 may be detached from their respective couplings at the pivot pins 142, 144 such that only the set of beams 110 form the foldable hazard warning panel 100

The foldable hazard warning panel 100 can be attached to a back of the vehicle 160 to be visible to other vehicles traveling towards the vehicle 160. The foldable hazard warning panel 100 can be attached to the vehicle by suitable hooking or hanging arrangement. The foldable hazard warning panel 100 comprises plurality of lights 150 which are operated by the battery of the vehicle itself by connecting the plurality of lights 150 to the battery by the power cable 155. Accordingly, the foldable hazard warning panel 100 can be utilized to facilitate other vehicles to spot that a hazardous situation may be present ahead of them and allow the other vehicles to take precautionary actions to avoid collisions and accidents. As can be seen in FIG. 6, the plurality of lights 150 provided on the set of beams 110 when turned ON indicate a hazard by assuming the shape of the triangle (as the set of beams 110 assumes the shape of the triangle).

Reference is now made to FIG. 7 that illustrates the foldable hazard warning panel 100 attached to another vehicle 170. As illustrated, the foldable hazard warning panel 100 is in a fully open state having the set of beams 110 as well as the first and second set of shafts 120, 130. The foldable hazard warning panel 100 can be attached to a back of the vehicle 170, for instance, by a hooking or hanging arrangement. Further, the plurality of lights 150 are operable by a battery of the vehicle 170 by virtue of the power cable 155. In the illustrated embodiment, other vehicles arriving towards the vehicle 170 may spot that a hazardous situation is present and take precautionary actions. Further, the other vehicles may easily identify a safe direction of travel (i.e., which direction to travel to safely pass the vehicle 170) from the first set of shafts 120 and/or the second set of shafts 130 in the form of arrows and having the plurality of lights 150 operated thereon. For instance, the plurality of lights 150 on the first set of shafts 120 (that resemble an arrow) may be turned ON (while the lights on the second set of shafts 130 are OFF) to indicate to the passing vehicles to pass the vehicle 170 from the left side of the vehicle 170.

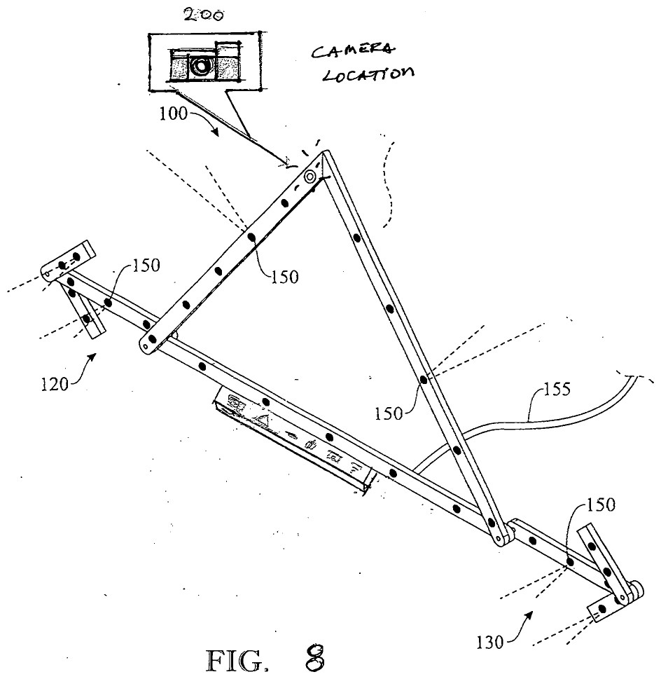

Reference is now made to FIG. 8 that illustrates the foldable hazard panel warning Panel 100 is in a fully open state, having the set of beams 110 as well as the first and second set of shafts 120, 130. At beam 114 there is a Camera lenses that is installed and inserted on the top area of beam 114, in order to provide live images to the user. This eye type camera is activated via a Bluetooth wireless connection from a smartphone equipped with the proper APP; accordingly the camera 200 will provide live images of oncoming traffic. This camera will enable the user to identify from its cabin when help is arriving. In particular for large vehicles such as semi-tractors with 53″ long trailers, where the foldable warning panel 100 will be attached, the driver can see when help is arriving during inclement weather, while been safe at the truck cabin.

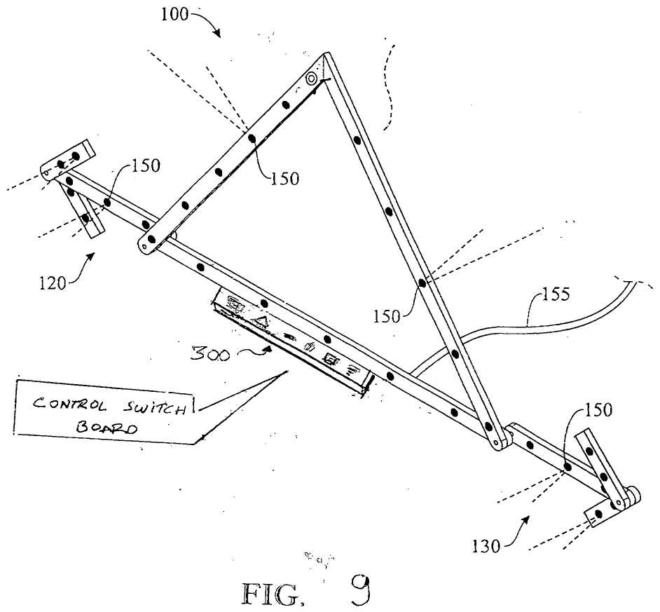

Reference is now made to FIG. 9 that illustrates the foldable hazard warning panel 100. As illustrated the foldable hazard warning panel is in a fully open state having the set of beams 110 as well as the first and second set of shafts 120, 130. Beam 110 shows attached to the bottom part the Control Switch Board 300, which displays the different modes of operation of the foldable hazard warning panel 100, in order to apply the desired functions for the foldable hazard warning panel 100 to operate, according to the existing conditions and circumstances it may be used.

Similarly, in another instance, the plurality of lights 150 on the second shafts 130 (that resemble an arrow) may be turned ON (while the lights of the first set of shafts 120 are OFF) to indicate to the passing vehicles to pass the vehicle 110 from the right side of the vehicle 110.

since many modifications, variations and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalent.

What is claimed is:

1. A foldable hazard warning panel configured to be deployed on a vehicle, the foldable hazard warning panel comprising
A set of beams;
A first set of shafts and a second set of shafts detachably and pivotally coupled to the set of beams; and
A mobile smartphone application compatible with the functionality of the device.
A power adaptor terminal that provides an energy source to the foldable panel, that connects to the license plate of the vehicle.
A USB rechargeable port.
A wireless Bluetooth capability connection to the foldable hazard warning panel.
A wired integrated heater thermostat device attached to its frame
A Solar panel cell is wired and attached to its frame and,
A Video Camera attached to one of its beams,
A plurality of lights provided on the set of beams and the first and second set of shafts.
Wherein the foldable hazard warning panel is configured to shift between a fully open state, a partially folded state, and a fully folded state, and
Wherein the plurality of lights are operative to indicate presence of a hazard, and a safe direction of travel.
